(19) United States
(12) Patent Application Publication
(10) Pub. No.: US 2025/0370263 A1
(43) Pub. Date: Dec. 4, 2025

(54) LENS MODULE AND NEAR-EYE DISPLAY DEVICE

(71) Applicants: Beijing Zitiao Network Technology Co., Ltd., Beijing (CN); LEMON INC., Grand Cayman (KY)

(72) Inventors: Hanning YANG, Beijing (CN); Ziyang ZHANG, Los Angeles, CA (US); Wei ZHANG, Beijing (CN); Yi LIU, Beijing (CN); Jian CHEN, Beijing (CN)

(21) Appl. No.: 19/090,221

(22) Filed: Mar. 25, 2025

(30) Foreign Application Priority Data
May 30, 2024 (CN) 202410685013.0

(51) Int. Cl. G02B 27/01; G02B 27/00

(52) U.S. Cl. CPC G02B 27/0172; G02B 27/0093; G02B 27/0176; G02B 2027/0138

(57) ABSTRACT

The present application discloses a lens module and near-eye display device, and relates to the technical field of near-eye display. The lens module includes a first lens group having a first surface facing eyes of a user and a first side surface connected to the first surface; a second lens group connected to one end, away from the eyes of the user, of the first lens group; along a direction away from an optical axis of the lens module, the second lens group protruding out of the first lens group to form a bearing platform; and the bearing platform being provided with first conductive pads; and at least one eye tracking light source disposed on the first side surface, and electrically connected with the first conductive pads through a conductive structure.

The present application claims priority to Chinese Patent Application No. 202410685013.0, filed on May 30, 2024, the disclosure of which is incorporated herein in its entirety as part of the present application.

### TECHNICAL FIELD

The present application belongs to the technical field of near-eye display, and in particular to a lens module and a near-eye display device.

### BACKGROUND

A virtual reality (VR) display technology usually needs to magnify a small-sized display screen display image through a lens before the display image is seen by human eyes of a user, and then the user can observe a large-sized display image, thereby achieving a high immersive effect.

In the related art, a virtual reality display device usually needs an eye tracking module to implement human-computer interaction. The eye tracking module includes an infrared lamp and an infrared camera, where the infrared lamp emits infrared light, and the infrared light is collected by the infrared camera after being reflected by corneas and pupils of human eyes, so that a motion state of the human eyes can be analyzed according to the reflection of the infrared light by the human eyes. The infrared lamp is usually mounted inside a lens cover, and a region of the lens cover corresponding to the infrared lamp uses a material that can transmit infrared light. In order to ensure the accurate fixing of the infrared lamps and the lens cover, positioning structures are designed at positions corresponding to the infrared lamps in the lens cover, and the positioning structures are located between the lens cover and a lens side surface, which will lead to the increase of a volume of the virtual reality display device.

### SUMMARY

An embodiment of the present application provides a lens module and a near-eye display device. By means of the lens module, the volume and weight of the near-eye display device can be reduced.

The present application provides a lens module for a near-eye display device, which includes a first lens group having a first surface facing eyes of a user and a first side surface connected to the first surface; a second lens group connected to one end, away from the eyes of the user, of the first lens group; along a direction away from an optical axis of the lens module, the second lens group protruding out of the first lens group to form a bearing platform; and the bearing platform being provided with first conductive pads; and at least one eye tracking light source disposed on the first side surface, and electrically connected with the first conductive pads through a conductive structure.

In some embodiments, the at least one eye tracking light source includes a plurality of eye tracking light sources, at least two of the plurality of eye tracking light sources are distributed at intervals along a circumferential direction of the lens module, and the plurality of eye tracking light sources are electrically connected with the first conductive pads through the conductive structure respectively.

In some embodiments, the conductive structure includes: a positive wire and a negative wire, a positive electrode of each of the plurality of eye tracking light sources is connected with a first conductive pad, of the first conductive pads, corresponding to the positive electrode through the positive wire, and a negative electrode of each of the plurality of eye tracking light sources is connected with a first conductive pad, of the first conductive pads, corresponding to the negative electrode through the negative wire.

In some embodiments, the lens module further includes second conductive pads, the second conductive pads are located on the first side surface, and electrodes of the plurality of eye tracking light sources are connected with the conductive structure through the second conductive pads.

In some embodiments, along the circumferential direction of the lens module, a dimension d1 of a second conductive pad of the second conductive pads satisfies: 0.05 mm≤d1≤1 mm.

In some embodiments, along a direction of the optical axis of the lens module, a dimension d2 of a second conductive pad of the second conductive pads satisfies: 0.05 mm≤d2≤1 mm.

In some embodiments, the plurality of eye tracking light sources and/or the electrodes of the plurality of eye tracking light sources are bonded to the first side surface.

In some embodiments, along a circumferential direction of the lens module, a width d3 of the conductive structure satisfies: 0.05 mm≤d3≤0.4 mm.

In some embodiments, along a direction towards the optical axis of the lens module, a thickness d4 of the conductive structure satisfies: 0.01 mm≤d4≤0.3 mm.

In some embodiments, a resistance R of the conductive structure satisfies: 10⁻⁵Ω≤R≤10⁻³Ω.

In some embodiments, the lens module further includes: a hardened protective layer covering at least the conductive structure and the first conductive pads.

In some embodiments, a material of the hardened protective layer includes a black material.

In some embodiments, along a direction towards the optical axis of the lens module, a thickness d5 of the hardened protective layer satisfies: 2 μm≤d5≤10 μm.

In some embodiments, the lens module further includes: a base layer, the base layer is located between the conductive structure and the first side surface and is used for increasing an adhesive strength between the conductive structure and the first side surface; and the base layer is also located between the hardened protective layer and the first side surface and is used for increasing an adhesive strength between the hardened protective layer and the first side surface.

In some embodiments, a material of the base layer includes a black material.

In some embodiments, along a direction towards the optical axis of the lens module, a thickness d6 of the base layer satisfies: 0.1 μm≤d6≤50 μm.

In some embodiments, the first side surface includes: an inclined section; along a direction towards the second lens group, a distance between the inclined section and the optical axis of the lens module gradually increases.

In some embodiments, an angle θ between the inclined section and a preset direction satisfies: 40°≤θ<90°; the preset direction is perpendicular to the optical axis of the lens module.

In some embodiments, a minimum distance d7 between an edge, away from the optical axis of the lens module, of the bearing platform and the first side surface satisfies: 1 mm≤d7≤10 mm.

The present application provides a near-eye display device, which includes: a lens cone and the lens module as mentioned above, the lens module is connected with the lens cone.

### BRIEF DESCRIPTION OF DRAWINGS

In order to illustrate the technical solutions in the embodiments of this application or in the prior art more clearly, a brief introduction will be given below to the accompanying drawings that need to be used in the description of the embodiments or the prior art. Obviously, the accompanying drawings in the following description are some embodiments of this application. For those of ordinary skill in the art, other accompanying drawings can also be obtained based on these drawings without creative efforts. In the accompanying drawings:

FIG. 1 is a structural schematic diagram of a lens module and a display screen provided by an embodiment of the present application;

FIG. 2A is a schematic diagram of electrical connection of eye tracking light sources in the lens module provided by the embodiment of the present application;

FIG. 2B is a schematic structural view of the lens module and the display screen with the electrical connection shown in FIG. 2A;

FIG. 3 is a structural schematic diagram of a lens module and a display screen provided by another embodiment of the present application; and

FIG. 4 is a structural schematic diagram of a lens module and a display screen provided by yet another embodiment of the present application.

### DESCRIPTION OF REFERENCE NUMERALS

100—lens module; 110—first lens group; 111—first side surface; 111a—inclined section; 120—second lens group; 121—bearing platform; 130—eye tracking light source; 140—conductive structure; 141—first positive wire; 142—first negative wire; 143—second positive wire; 144—second negative wire; 150—first conductive pad; 160—second conductive pad; 170—hardened protective layer; 180—base layer; 200—display screen; O—optical axis; 310—lens cone; 320—bracket.

### DETAILED DESCRIPTION

The embodiments of the present application will be described in detail below. Examples of the embodiments are shown in the accompanying drawings. The embodiments described below by referring to the accompanying drawings are exemplary and are intended to explain the present application, and shall not be construed as a limitation on the present application.

It should be understood that the various steps described in the method embodiments of the present disclosure can be executed in different orders and/or executed in parallel. In addition, the method embodiments may include additional steps and/or omit the execution of the illustrated steps. The scope of the present disclosure is not limited in this aspect.

The term “comprise” or “include” and its variations used in this article are open-ended, that is, “comprising but not limited to” or “including but not limited to”. The term “based on” means “based at least in part on”. The term “one embodiment” means “at least one embodiment”; the term “another embodiment” means “at least one additional embodiment”; the term “some embodiments” means “at least some embodiments”. The relevant definitions of other terms will be given in the following description.

It should be noted that the concepts such as “first” and “second” mentioned in the present application are only used to distinguish different devices, modules or units, and are not intended to limit the order of the functions performed by these devices, modules or units or their interdependent relationships.

It should be noted that the modifiers like “a” and “plurality” mentioned in the present application are illustrative rather than restrictive. Those skilled in the art should understand that, unless otherwise clearly indicated in the context, they should be understood as “one or more”.

The names of the messages or information exchanged among multiple devices in the embodiments of the present disclosure are only for illustrative purposes and are not used to limit the scope of these messages or information.

First, some nouns or terms appearing in the description of the embodiments of the present application are explained as follows.

Virtual reality (VR) is a technology for creating and experiencing the virtual world, which computes and generates a virtual environment and integrates multi-source information (virtual reality mentioned herein includes at least visual perception, as well as auditory perception, tactile perception, motion perception, even taste perception, smell perception, etc.) to realize the simulation of an integrated and interactive three-dimensional dynamic scene and physical behaviors of a virtual environment, so that users can be immersed into the simulated virtual reality environment. It has found its applications in a variety of virtual environments such as maps, games, videos, education, medical care, simulation, collaborative training, sales, assistance in manufacturing, maintenance and repair.

A virtual reality device is a terminal for achieving a virtual reality effect, which can usually be provided in the form of glasses and a head mount display (HMD) for implementing visual perception and other forms of perception. Of course, the implementation form of the virtual reality device is not limited to this, and it can be further miniaturized or enlarged as needed.

An existing virtual reality display technology needs to magnify the display image in the small-sized display screen through the lens module before the display image is seen by human eyes, so that the user can observe a large-sized display image, thereby achieving a high immersive effect. Small-sized display screens usually include an LCD or a Micro-OLED or a Micro-LED, and lens modules usually include traditional geometric lenses, Fresnel lenses or folded optical path lenses. In order to achieve thinness and high optical performance, the virtual reality display device usually adopts a folded optical path lens technology based on polarization optics.

In the related art, the virtual reality display device usually includes: a lens module and a display screen, where the lens module is fixed to a lens cone, the display screen is fixed to a bracket, and the lens cone is connected with the bracket; and the lens cone is usually made of black resin with high strength, and the bracket is usually made of high-strength resin or metal. In order to prevent an edge of the lens from being scratched and enhance the protective performance of the lens module, a lens cover, generally made of resin, is usually mounted on the lens cone and the lens module; and the lens cover is fixed to the lens or the lens cone by mechanical buckling. In order to prevent a situation that external stray light is incident from the side of the lens module and is folded back multiple times and then enters human eyes to form stray light that reduces the contrast of a display image, the lens cover is generally made of a material that strongly absorbs a visible light band.

In order to make the user have a better interaction experience during use, the virtual reality display device is also provided with an eye tracking module. The eye tracking module includes an infrared lamp and an infrared camera, where the infrared lamp emits infrared light, and the infrared light is collected by the infrared camera after being reflected by corneas and pupils of human eyes, so that a motion state of the human eyes can be analyzed according to the reflection of the infrared light by the human eyes. In order to reduce the volume of the virtual reality display device, the infrared lamp can be placed inside the lens cover. At this time, in order to ensure that infrared light can pass through the lens cover and irradiate human eyes, a region of the lens cover corresponding to the infrared lamp is necessarily uses a material that can transmit infrared light. Because the infrared light emitted by the infrared lamp needs to be reflected by the human eyes and then received by the infrared camera, a mounting position of the infrared lamp requires high accuracy in order to achieve clear imaging.

In the related art, the lens cover and the lens cone are usually assembled by mechanical buckling, but the assembly accuracy of a buckling process is difficult to meet the requirements of the infrared lamp for the high-precision mounting position. When the mounting position of the infrared lamp deviates greatly, there will be a problem that the human eyes cannot be effectively irradiated, which will further affect the accuracy of eye tracking. In order to ensure the accurate fixing of the infrared lamps and the lens cover, positioning structures can be designed at positions corresponding to the infrared lamps in the lens cover, and the positioning structures are located between the lens cover and the lens side surface, but this will lead to the increase of the size of the lens cover, further leading to the increase of the volume of the virtual reality display device.

In order to overcome the above technical problems, this embodiment provides a lens module and a near-eye display device. A side surface of a first lens group is closer to an optical axis of the lens module than a side surface of a second lens group, eye tracking light sources are mounted on the side surface of the first lens group, a conductive structure required by the eye tracking light sources is disposed on the side surface of the first lens group, and first conductive pads are disposed on a portion, protruding out of the first lens module, of the second lens group along a direction away from the optical axis of the lens module, so that the eye tracking light sources can be electrically connected with a circuit board outside the lens module through the conductive structure and the first conductive pads, the realization of an eye tracking function is ensured, there is no need to set a positioning structure for accurately fixing the eye tracking light source between a lens cover and a lens cone, and it is beneficial to reducing a size of the lens cover, thereby reducing the volume and weight of the near-eye display device.

The technical solution of the present application and how the technical solution of the present application solves the above technical problems will be described in detail with specific embodiments. The following specific embodiments may be combined with each other, and the same or similar concepts or processes may not be repeated in some embodiments. The embodiments of the present application will be described below with reference to the accompanying drawings.

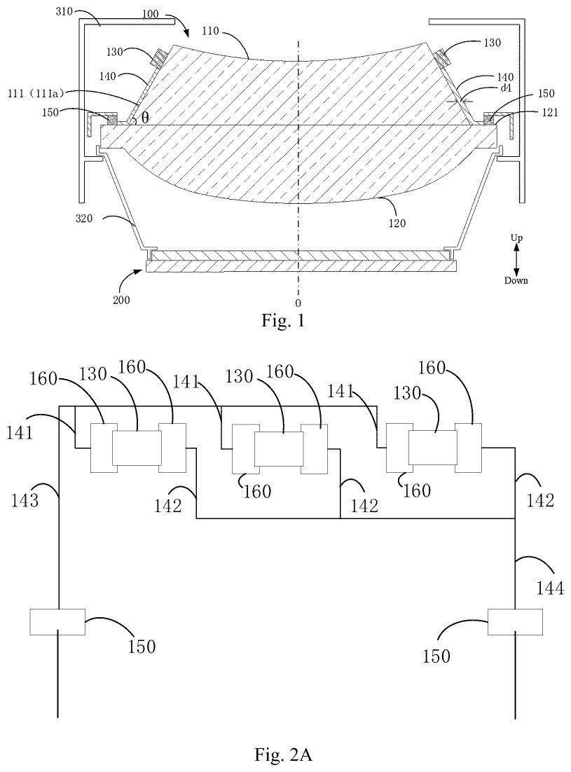

FIG. 1 is a structural schematic diagram of a lens module and a display screen provided by an embodiment of the present application. With reference to FIG. 1, the near-eye display device provided by this embodiment may include: a lens module, a lens cone, a lens cover (not shown) and a bracket. The lens module is connected with the lens cone, the lens cover is connected with the lens module or the lens cone in a buckling manner, the lens cone is connected with the bracket, and a display screen is fixed to the bracket. The lens cone is usually made of a black resin material with high strength. The bracket can be made of high-strength resin or metal. The lens cover may be made of a material that strongly absorbs the visible light band, so as to prevent a situation that external stray light is incident from the side of the lens module and is folded back multiple times and then enters human eyes to form stray light that reduces the contrast of the display image.

Exemplarily, the lens module generally includes: optical lenses and a polarizing film, where, a number of the optical lenses is usually plural. The polarizing film usually includes at least one selected from the group consisting of a quarter-wave plate (QWP), a polaroid (POL), a reflective polarizing film (RP). The polarizing films can be sequentially stacked on an outer surface, close to a human eye side, of the optical lens, or distributed between different optical lenses.

For the convenience of description, a direction of the lens module towards the eyes of the user is taken as “up” and a direction of the lens module towards the display screen is taken as “down”.

Light emitted by the display screen is converted into circularly polarized light after passing through a circularly polarized composite film; the circularly polarized light enters an interior of the lens through a beam splitting layer (BS) close to a display screen side of the lens; the circularly polarized light entering the interior of the lens passes through the quarter-wave plate (QWP) and is then converted into linearly polarized light; the linearly polarized light irradiates the reflective polarizing film (RP) and is reflected downwards; the linearly polarized light reflected downwards passes through QWP again and becomes circularly polarized light reflected downwards again; the circularly polarized light reflected downwards irradiates the BS and is reflected upwards, and a phase difference of the circularly polarized light reflected upwards increases by half a wavelength due to half-wave loss; the circularly polarized light reflected upwards, after passing through QWP, is converted into vertically polarized linearly polarized light, and then passes through the RP and the POL and irradiates eyes of a user, so that the user is immersed in a simulated virtual reality environment.

Next, a specific structure of the lens module of this embodiment will be illustrated. It can be understood that other configurations and functions of the lens module of the present embodiment are known to those skilled in the art, and will not be described here in order to reduce redundancy.

The lens module 100 includes: a first lens group 110 and a second lens group 120. The first lens group 110 is closer to eyes of a user than the second lens group 120. That is, the second lens group 120 is located on a side, facing a display screen 200, of the first lens group 110. The first lens group 110 and the second lens group 120 each include at least one optical lens. Exemplarily, the first lens group 110 may include one optical lens or two optical lenses or three optical lenses or four optical lenses, or more than four optical lenses. The second lens group 120 may include one optical lens or two optical lenses. For example, the first lens group 110 may include two optical lenses, and the second lens group 120 may include one optical lens.

The optical lenses of the first lens group 110 and the optical lenses of the second lens group 120 are fixed into a whole by gluing or framing. Optical functional films, such as a polarizing film, are bonded to a surface, close to a human eye side, of the first lens group 110 or bonded to surfaces of different optical lenses through a bonding process. In this embodiment, a specific setting position of the polarizing film is not limited, and can be set according to actual needs. In addition, in order to reduce the reflection of the surface of the optical lens near the eyes of the user, an anti-reflection layer is bonded or deposited on the surface of the optical lens (that is, the surface, facing the eyes of the user, of the first lens group 110).

The lens module 100 has an optical axis O. For convenience of description, a direction of the lens module 100 towards the optical axis O will be taken as inward and a direction of the lens module 100 away from the optical axis O will be taken as outward.

An outer edge of the first lens group 110 is located on an inner side of an outer edge of the second lens group 120. That is, a distance between a second side surface of the second lens group 120 and the optical axis O of the lens module 100 is greater than a distance between a first side surface 111 of the first lens group 110 and the optical axis O of the lens module 100. Along the direction of the optical axis O of the lens module 100, the first lens group 110 has two surfaces distributed at intervals, one of the surfaces, namely the first surface, is closer to the eyes of the user than the other surface, and the two surfaces are connected by the first side surface 111. Similarly, along the direction of the optical axis O of the lens module 100, the second lens group 120 has two surfaces distributed at intervals, one of the surfaces is closer to the eyes of the user than the other surface, and the two surfaces are connected by the second side surface.

The first side surface 111 of the first lens group 110 may be formed after a cutting process. Specifically, before the cutting process is started, both the first lens group 110 and the second lens group 120 have original outer edges, and the original outer edge of the first lens group 110 may be flush with that of the second lens group 120. After the cutting process is started, a portion, close to the original outer edge, of the first lens group 110 is precisely cut by a cutting device such as a numerical control machine tool, so that a new outer edge formed after the first lens group 110 is cut is located on the inner side of the outer edge of the second lens group 120. With respect to the second lens group 120, the second lens group 120 may not be cut, or along the direction perpendicular to the optical axis O of the lens module 100, a cut amount of the second lens group 120 is less than that of the first lens group 110, so that a new outer edge formed after the first lens group 110 is cut is finally located on an outer side of the outer edge of the second lens group 120.

It can be understood that the first lens group 110 and the second lens group 120 have an optical effective region and an optical ineffective region respectively, and the optical ineffective region is located at a periphery of the optical effective region. The optical effective region refers to a region where the lens group participates in optical imaging. The optical ineffective region refers to a region where the lens group does not participate in optical imaging. A portion of the first lens group 110 that is removed is located in the optical ineffective region.

In this embodiment, due to the removal of the portion, close to the outer edge, of the first lens group 110, the weight of the first lens group 110 can be reduced, so that the weight of the lens module 100 can be reduced, and the weight of the near-eye display device can further be reduced.

Along the direction away from the optical axis O of the lens module 100, the portion, protruding out of the first lens group 110, of the second lens group 120 forms a bearing platform 121 to be connected with the lens cone 310 of the near-eye display device. For example, the lens cone 310 is connected to a bracket 320 for fixing the display screen 200. Exemplarily, a cross section of the bearing platform 121 along the direction perpendicular to the optical axis O of the lens module 100 may be circular or elliptical or in other shapes. An upper surface, facing the eyes of the user, of the bearing platform 121 and a lower surface of the bearing platform may both be flat.

The lens module 100 further includes: an eye tracking light source 130, where the eye tracking light source 130 is disposed on the first side surface 111, and is electrically connected with the first conductive pad 150 located on the bearing platform 121 through the conductive structure 140. The conductive structure 140 is at least partially located on the first side surface 111. The eye tracking light source 130 can be fixed on the first side surface 111 by bonding or the like. The conductive structure 140 can be made of conductive materials such as silver paste, copper paste or gold paste. In a specific implementation, the conductive structure 140 can be formed on the first side surface 111 through a printing process.

Exemplarily, because the eye tracking light source is driven by the positive electrode and the negative electrode, the positive electrode and the negative electrode of the eye tracking light source are respectively connected with the conductive structure 140, the conductive structure 140 can extend to the first conductive pads 150, and the first conductive pads 150 can be electrically connected with a circuit board outside the lens module 100, thereby electrically connecting the eye tracking light source with the circuit boards outside the lens module 100.

The first conductive pad 150 is a structure made of a conductive material and is used for electrically connecting the conductive structure 140 with the circuit board outside the lens module 100. The first conductive pad 150 may be other structures with conductive properties, as long as it can achieve the above functions.

In some examples, the first conductive pad 150 may be specifically disposed on the upper surface of the bearing platform 121. Exemplarily, two preset regions with relatively large areas are disposed at the upper surface of the bearing platform 121, the first conductive pads 150 are respectively provided in the two preset regions, and the two first conductive pads 150 respectively correspond to the positive electrode and the negative electrode of the eye tracking light source. The two first conductive pads 150 may be symmetrically distributed about the optical axis O of the lens module 100. In other examples, the bearing platform 121 may be provided with a groove, a groove opening of the groove is located in the upper surface of the bearing platform 121; at least a part of the first conductive pad 150 is located in the groove, and the upper surface of the first conductive pad 150 may be flush with the upper surface of the bearing platform 121, or the upper surface of the first conductive pad 150 may be slightly higher than the upper surface of the bearing platform 121.

The two first conductive pads 150 are respectively electrically connected with a positive electrode and a negative electrode of the circuit board outside the lens module 100. For example, the two first conductive pads 150 are connected to the positive and negative electrodes of the flexible printed circuit board by welding or binding, and a material for connection may be a conductive material such as an anisotropic conductive adhesive or soldering tin; and the flexible printed circuit board is also connected with a main control circuit board of the near-eye display device by buckling and other means.

In this embodiment, by cutting the optical ineffective region of the first lens group 110, it is beneficial to reducing the weight of the lens module 100; further, the eye tracking light sources 130 are disposed on the first side surface 111 obtained after cutting, a conductive structure 140 required by the eye tracking light sources 130 is disposed on the side surface of the first lens group 110, and the first conductive pads 150 are disposed on a portion, protruding out of the first lens module 100, of the second lens group 120 along a direction away from the optical axis O of the lens module 100, so that the eye tracking light sources 130 can be electrically connected with a circuit board outside the lens module 100 through the conductive structure 140 and the first conductive pads 150, the realization of an eye tracking function is ensured, there is no need to set a positioning structure for accurately fixing the eye tracking light source 130 between the lens cover and the lens cone, and it is beneficial to reducing the size of the lens cover, thereby reducing the volume and weight of the near-eye display device.

In addition, in this embodiment, the eye tracking light sources 130 are directly connected to the first side surface 111, and the eye tracking light sources 130 are in surface-to-surface contact connection with the first side surface 111, which is more conducive to ensuring the assembly accuracy of the eye tracking light sources and the first lens group 110, thereby meeting the high-precision requirements of the eye tracking light sources 130 on mounting positions.

In some embodiments, in order to ensure the connection reliability between the electrodes of the eye tracking light source and the conductive structure 140, the lens module 100 further includes second conductive pads 160, the second conductive pads 160 are located on the first side surface 111, and the electrodes of the eye tracking light source 130 are connected with the conductive structure 140 through the second conductive pads 160.

The second conductive pad 160 is a flat structure made of a conductive material, and is used for electrically connecting the eye tracking light source 130 with the conductive structure 140. The second conductive pad 160 may be other structures with conductive properties, as long as it can achieve the above functions.

In some examples, the second conductive pad 60 may be directly disposed on the first side surface 111. In other examples, the second conductive pad 160 is embedded in the first lens group 120, and a surface of the second conductive pad 160 may be flush with the first side surface 111, or the surface of the second conductive pad 160 may protrude out of the first side surface 111 along the direction away from the optical axis O of the lens module 100.

The electrodes of the eye tracking light source include a positive electrode and a negative electrode. The positive electrode and the negative electrode of the eye tracking light source 130 respectively correspond to the second conductive pads 160, and the second conductive pads 160 can be set relatively large. The positive electrode and the negative electrode of the eye tracking light source 130 can be connected with the corresponding second conductive pads 160 by welding or binding, and a material for connection may be a conductive material such as anisotropic conductive adhesive or soldering tin.

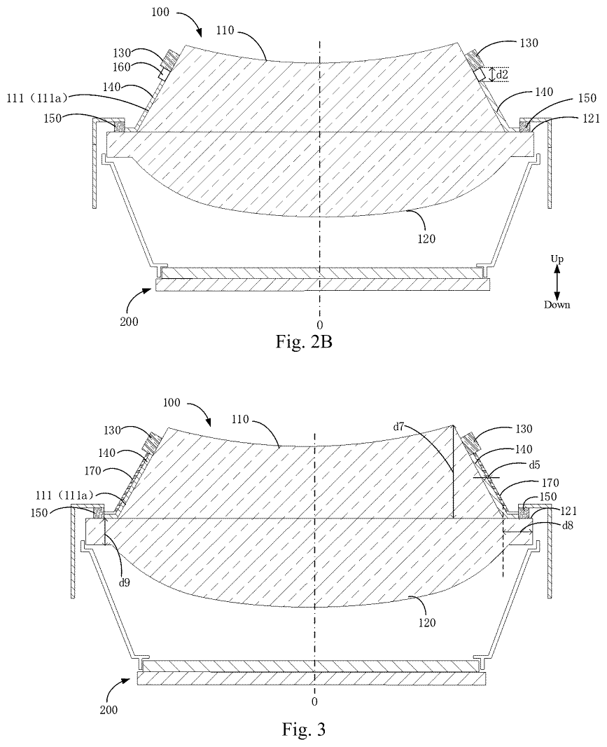

FIG. 2A is a schematic diagram of electrical connection of eye tracking light sources in the lens module provided by the embodiment of the present application. With reference to FIG. 2A and continued reference to FIG. 1, exemplarily, the second conductive pad 160 has a polygonal shape. For example, the second conductive pad 160 may have a rectangular or regular pentagonal shape. In other examples, the second conductive pad 160 may also have a circular or elliptical shape.

Optionally, along the circumferential direction of the lens module 100, a dimension d1 of the second conductive pad 160 satisfies: 0.05 mm≤d1≤1 mm. Where, mm represents millimeter. Exemplarily, d1 may be 0.05 mm or 0.1 mm or 0.2 mm or 0.3 mm or 0.4 mm or 0.5 mm or 0.6 mm or 0.7 mm or 0.8 mm or 0.9 mm or 1.0 mm, or a dimension ranging between any two of the above. Through the above arrangement, the connection reliability between the electrodes of the eye tracking light source and the conductive structure 140 can be ensured, and the self weight of the lens module 100 can be reduced.

Optionally, as illustrated in FIG. 2B, along the direction of the optical axis O of the lens module 100 (i.e., in an up-down direction in FIG. 1), a dimension d2 of the second conductive pad 160 satisfies: 0.05 mm≤d2≤1 mm. Exemplarily, d2 may be 0.05 mm or 0.1 mm or 0.2 mm or 0.3 mm or 0.4 mm or 0.5 mm or 0.6 mm or 0.7 mm or 0.8 mm or 0.9 mm or 1.0 mm, or a dimension ranging between any two of the above. Through the above arrangement, the connection reliability between the electrodes of the eye tracking light source and the conductive structure 140 can be ensured, and the self weight of the lens module 100 can be reduced.

Optionally, the electrodes of the eye tracking light source 130 are bonded to the first side surface 111. For example, a portion, close to the edge, of the eye tracking light source 130 can be bonded to the first side surface 111 by dispensing glue, and the glue used can include resin such as acrylate or polyurethane. In this way, the connection reliability between the eye tracking light source 130 and the first side surface 111 can be further improved, and the connection reliability between the electrodes of the eye tracking light source 130 and the second conductive pads 160 can be improved, so that the eye tracking light source 130 can be effectively prevented from falling off during a reliability test or when the user uses the near-eye display device.

In some embodiments, a number of eye tracking light sources is plural, where at least two of the eye tracking light sources 130 are distributed at intervals along the circumferential direction of the lens module 100. The higher the number of the eye tracking light sources 130 is, the better the accuracy of eye tracking is. For example, the number of the eye tracking light sources 130 may be two, and the two eye tracking light sources 130 may be symmetrically disposed about the optical axis O of the lens module 100. Alternatively, the number of the eye tracking light sources 130 may be three, the three eye tracking light sources 130 are distributed at intervals along the circumferential direction of the lens module 100, and a distance between every two adjacent eye tracking light sources 130 along the circumferential direction of the lens module 100 may be equal. Alternatively, the number of the eye tracking light sources 130 may be four, two of the four eye tracking light sources 130 may be located on a center line of the lens module 100 in a left-right direction in the figure, and the other two of the eye tracking light sources 130 may be located on a center line of the lens module 100 in a front-back direction in the figure. Of course, the specific number and distribution positions of the eye tracking light sources 130 are not limited to this, and this embodiment is only for illustration here.

A plurality of eye tracking light sources 130 are electrically connected with the first conductive pads 150 through the conductive structure 140. Respective eye tracking light sources 130 are arranged in parallel and then each eye tracking light source is connected in series with two first conductive pads 150 corresponding to the positive electrode and negative electrode of the eye tracking light source. The second conductive pads 160 corresponding to respective eye tracking light sources 130 are also disposed independently of each other. In this way, when one of the eye tracking light sources 130 fails, the normal operation of the other eye tracking light sources 130 will not be affected.

In some examples, in order to simplify the wiring in the lens module 100, the positive electrode and the negative electrode of each eye tracking light source 130 are respectively connected with a wiring, and wirings corresponding to the positive electrodes of respective eye tracking light sources 130 are connected with the first conductive pad 150 corresponding to the positive electrodes through another wiring. Similarly, wirings corresponding to the negative electrodes of respective eye tracking light sources 130 are connected with the first conductive pad 150 corresponding to the negative electrodes through another wiring.

With continued reference to FIGS. 1 and 2A, specifically, the conductive structure 140 includes: a positive wire and a negative wire, where a positive electrode of each the eye tracking light source 130 is connected with the first conductive pad 150 corresponding to the positive electrode through the positive wire, and a negative electrode of each eye tracking light source 130 is connected with the first conductive pad 150 corresponding to the negative electrode through the negative wire.

Exemplary, the positive wires include: a first positive wire 141 and a second positive wire 143; and the negative wires include: a first negative wire 142 and a second negative wire 144. The number of the first positive wire 141 and the number of the first negative wire 142 are respectively equal to the number of the eye tracking light sources. The number of the second positive wire 143 and the number of the second negative wire 144 are less than that of the first positive wires 141 and that of the first negative wires 142, respectively. Alternatively, there may be one second positive wire 143 and one second negative wire 144 respectively, and routing directions of the second positive wire 143 and the second negative wire 144 may be set according to actual needs.

One end of each first positive wire 141 is connected with the positive electrode of the eye tracking light source, the other end of each first positive wire 141 is also connected with the second positive wire 143, and the second positive wire 143 is connected with the first conductive pad 150 corresponding to the positive electrode; one end of each first negative wire 142 is connected to the negative electrode of the eye tracking light source 130, the other end of each first negative wire 142 is also connected to the second negative wire 144, and the second negative wire 144 is connected to the first conductive pad 150 corresponding to the negative electrode.

In other examples, the conductive structure 140 includes: third positive wires and third negative wires, where a number of third positive wires and a number of the number of are equal to that of the eye tracking light sources, one end of each third positive wire is connected with the positive electrode of the eye tracking light source, the other end of each third positive wire is connected with the first conductive pad 150 corresponding to the positive electrode, one end of each third negative wire is connected with the negative electrode of the eye tracking light source, and the other end of each third negative wires is connected with the first conductive pad 150 corresponding to the negative electrode.

With continued reference to FIG. 1, in some embodiments, along the circumferential direction of the lens module 100, a width d3 of the conductive structure 140 satisfies: 0.05 mm≤d3≤0.4 mm. For example, d3 may be 0.05 mm or 0.1 mm or 0.15 mm or 0.2 mm or 0.25 mm or 0.3 mm or 0.35 mm or 0.4 mm, or a dimension ranging between any two of the above. Through the above arrangement, it is ensured that the conductive structure 140 can reliably connects the eye tracking light source with the first conductive pad 150, and the self weight of the lens module 100 can be reduced.

With continued reference to FIG. 1, in some embodiments, along a direction towards the optical axis O of the lens module 100 (that is, along the left-right direction in FIG. 1), a thickness d4 of the conductive structure 140 satisfies: 0.01 mm≤d4≤0.3 mm. Exemplarily, d4 may be 0.01 mm or 0.05 mm or 0.1 mm or 0.15 mm or 0.2 mm or 0.25 mm or 0.3 mm, or a dimension ranging between any two of the above. Through the above arrangement, it is ensured that the conductive structure 140 can reliably connects the eye tracking light source with the first conductive pad 150, and the self weight of the lens module 100 can be reduced.

In some embodiments, in order to reduce the power of the conductive structure 140 and reduce the cost of the near-eye display device, a resistance R of the conductive structure 140 satisfies: 10⁻⁵Ω≤R≤10⁻³Ω. Where, Ω represents ohm. For example, R may be 10⁻⁵Ω or 10⁻⁴Ω or 10⁻³Ω, or a resistance value ranging between any two of the above. The resistance R may be specifically set according to actual needs, and this embodiment is not specifically limited here.

FIG. 3 is a structural schematic diagram of a lens module and a display screen provided by another embodiment of the present application. With reference to FIG. 3, in some embodiments, in order to prevent the conductive structure 140 from being damaged due to scratch during the reliability test or when the user uses the near-eye display device, the lens module 100 further includes: a hardened protective layer 170, where the hardened protective layer 170 covers at least the conductive structure 140. The hardened protective layer 170 can completely wrap the conductive structure 140 to prevent the conductive structure 140 from being exposed. In addition, the hardened protective layer 170 can also cover the first conductive pad 150 and/or the second conductive pad 160.

The hardened protective layer 170 can be formed on the first side surface 111 by coating or inkjet printing. The hardened protective layer 170 needs to be made of an insulating material, and this material has certain scratch resistance after hardening. For example, the material of the hardened protective layer 170 may include acrylate.

Optionally, the material of the hardened protective layer 170 includes a black material, so that the hardened protective layer 170 can also have light absorption performance. In this way, the hardened protective layer 170 can also absorb external light, thereby preventing the external light from entering the eyes of the user after multiple reflections, and further improving the display contrast. The material of the hardened protective layer 170 may be a black organic material. For example, the material of the hardened protective layer 170 may include a mixture of carbon powder and acrylate. An elastic modulus E of the hardened protective layer 170 can satisfy: 0.1 Gpa≤E≤4 Gpa; where, GPa stands for ten thousand megapascals.

Optionally, along the direction towards the optical axis O of the lens module 100 (in the left-right direction in the figure), a thickness d5 of the hardened protective layer 170 satisfies: 2 μm≤d5≤10 μm. Where, μm stands for micrometer. For example, d5 may be 2 μm, 3 μm, 4 μm, 5 μm, 6 μm, 7 μm, 8 μm, 9 μm or 10 μm, or a thickness ranging between any two of the above. Through the above arrangement, the protective performance of the hardened protective layer 170 to the conductive structure 140 and the light absorption performance of the hardened protective layer 170 can be ensured, and at the same time, it is beneficial to reducing the self weight of the lens module 100.

Optionally, the hardened protective layer 170 may cover the entire first side surface 111 to protect the side of the lens module; moreover, when the hardened protective layer 170 has light absorption performance, it can also prevent external light from entering the eyes of the user after multiple reflections. In addition, the hardened protective layer 170 may extend to the entire upper surface of the bearing platform 121.

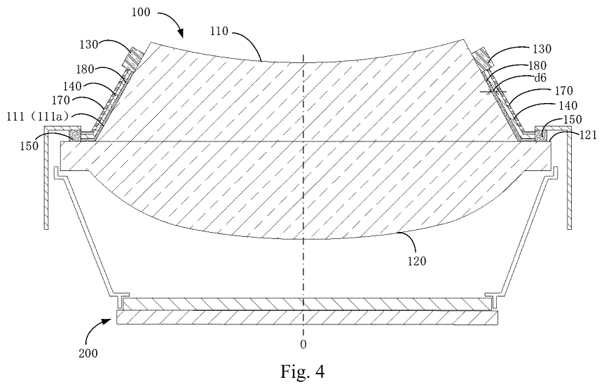

FIG. 4 is a structural schematic diagram of a lens module and a display screen provided by yet another embodiment of the present application. With reference to FIG. 4, in some embodiments, because the optical lens usually has low surface energy, the adhesive strength between the first side surface 111 and each of the conductive structure 140 and the hardened protective layer 170 is low. In order to improve the adhesive strength between the first lens group 110 and each of the conductive structure 140 and the hardened protective layer 170 and prevent the conductive structure 140 and the hardened protective layer 170 from falling off, the lens module 100 may further include: a base layer 180, where the base layer 180 is located between the conductive structure 140 and the first side surface 111 and is used for increasing the adhesive strength between the conductive structure 140 and the first side surface 111; and the base layer 180 is also located between the hardened protective layer 170 and the first side surface 111 and is used for increasing the adhesive strength between the hardened protective layer 170 and the first side surface 111.

The base layer 180 can be processed on the first side surface 111 by coating, inkjet printing and other processes. The specific material of the base layer 180 can be selected according to actual needs, as long as the adhesive strength between the first side surface 111 and each of the conductive structure 140 and the hardened protective layer 170 can be improved, that is, as long as the connection reliability between the first side surface 111 and each of the conductive structure 140 and the hardened protective layer 170 can be improved.

In addition, the base layer 180 may also be located between the first conductive pad 150 and the upper surface of the bearing platform 121; and/or, the base layer 180 may also be located between the second conductive pad 160 and the first side surface 111; and/or, the base layer 180 may also be located between the hardened protective layer 170 and the upper surface of the bearing platform 121.

Optionally, the material of the base layer 180 includes the black material in order to be able to absorb external stray light. The specific material of the base layer 180 can be selected according to actual needs, as long as it can improve the connection reliability between the optical lens and each of the conductive structure 140 and the hardened protective layer 170, and can absorb external stray light.

Optionally, along the direction towards the optical axis O of the lens module 100 (in the left-right direction in the figure), a thickness d6 of the base layer 180 satisfies: 0.1 μm≤d6≤50 μm. Exemplarily, d6 may be 0.1 μm or 5 μm or 10 μm or 15 μm or 20 μm or 25 μm or 30 μm or 35 μm or 40 μm or 45 μm or 50 μm, or a thickness ranging between any two of the above. Through the above arrangement, it is ensured that the base layer 180 can reliably connect the conductive structure 140 and the hardened protective layer 170 with the optical lens, and it is beneficial to reduce the self weight of the lens module 100.

With reference to FIG. 1 or FIG. 3 or FIG. 4, in some embodiments, the first side surface 111 includes an inclined section 111a; and along a direction towards the second lens group 120, a distance between the inclined section 111a and the optical axis O of the lens module 100 gradually increases.

In some examples, along the direction of the optical axis O of the lens module 100, the entire side surface of the first lens group 110 is inclined; that is, the entire side surface of the first lens group 110 is an inclined section 111a. In other words, the first side surface 111 gradually moves away from the optical axis O of the lens module 100 in the direction from top to bottom.

In other examples, along the direction of the optical axis O of the lens module 100, the first side surface 111 may include a straight surface section and an inclined section 111a, where the straight surface section is smoothly connected with the inclined section 111a, the straight surface section may be connected to an upper side of the inclined section 111a, or the straight surface section may be connected to a lower side of the inclined section 111a; moreover, a distance between the inclined section 111a and the optical axis O of the lens module 100 gradually increases in the direction from top to bottom.

Optionally, an angle θ between the inclined section 111a and a preset direction satisfies: 40°≤θ <90°; where, the preset direction is perpendicular to the optical axis O of the lens module 100, and the preset direction may be the left-right direction in the figure. For example, the angle θ may be 40° or 45° or 50° or 55° or 60° or 65° or 70° or 75° or 80° or 85° or 89°, or an angle ranging between any two of the above.

Optionally, along the direction of the optical axis O of the lens module 100 (along the up-down direction in the figure), a height d7 of the inclined section 111a satisfies: 1 mm≤d7≤10 mm. Exemplarily, d7 may be 1 mm or 2 mm or 3 mm or 4 mm or 5 mm or 6 mm or 7 mm or 8 mm or 9 mm or 10 mm, or a height ranging between any two of the above.

In this embodiment, through the above arrangement, it is convenient to cut the lens module 100, and the side surface of the lens module 100 has a relatively large side area, which facilitates the arrangement of the eye tracking light source 130 and other structures on the first side surface 111.

In other embodiments, the first side surface 111 can also be a straight surface section wholly, that is, the first side surface 111 can also be parallel to the optical axis O of the lens module 100.

In some embodiments, a minimum distance d8 between an edge, away from the optical axis O of the lens module 100, of the bearing platform 121 and the first side surface 111 satisfies: 0.3 mm≤d8≤5 mm. The minimum distance between the edge, away from the optical axis O of the lens module 100, of the bearing platform 121 and the first side surface 111 may be a distance between the edge, facing away from the optical axis O of the lens module 100, of the bearing platform 121 and a lower end of the first side surface 111. Exemplarily, d8 may be 0.3 mm or 0.5 mm or 1 mm or 1.5 mm or 2 mm or 2.5 mm or 3 mm or 4 mm or 3.5 mm or 4.5 mm or 5 mm, or a distance ranging between any two of the above.

Along the direction of the optical axis O of the lens module 100 (in the up-down direction in the figure), a thickness d9 of the bearing platform 121 satisfies: 0.5 mm≤d9≤5 mm. Exemplarily, d9 may be 0.5 mm or 1 mm or 1.5 mm or 2 mm or 2.5 mm or 3 mm or 3.5 mm or 4 mm or 4.5 mm or 5 mm, or a distance ranging between any two of the above.

In this embodiment, through the above arrangement, it is ensured that the bearing platform 121 and the lens cone can be reliably connected, and the bearing platform 121 will not be too large to increase the weight of the lens module 100.

In some embodiments, the outer side, facing away from the optical axis O of the lens module 100, of the bearing platform 121 includes at least one positioning edge, which is flat and straight.

In a specific implementation, one side of the bearing platform 121 can be cut straight to obtain a flat and straight positioning edge. Alternatively, the two opposite sides or adjacent sides of the bearing platform 121 are cut straight to obtain two flat and straight positioning edges. Alternatively, three or more sides of the bearing platform 121 are cut straight to obtain a corresponding number of flat and straight positioning edges. The specific number of the positioning edges can be set according to actual needs, and this embodiment is not limited here.

In this embodiment, through the above arrangement, when the lens module 100 and the lens cone 310 are assembly, it is convenient for the bearing platform 121 to be positioned with the lens cone 310 through the positioning edges, thus facilitating the improvement of the assembly quality and efficiency of the lens module 100 and the lens cone 310.

This embodiment also provides a lens module 100. The structure, functions and implementation processes of the lens module 100 are the same as those of any of the previous embodiments, and are omitted here in this embodiment.

It should be noted that in this application, when the first feature is “on”, “above” or “over” the second feature, it can mean that the first feature is exactly above or obliquely above the second feature, or it merely indicates that the horizontal height of the first feature is higher than that of the second feature. When the first feature is “under”, “below” or “beneath” the second feature, it can mean that the first feature is exactly below or obliquely below the second feature, or it merely indicates that the horizontal height of the first feature is lower than that of the second feature.

It can be understood that in the attached drawings, sometimes for the sake of clarity, the size of components, the thickness of layers or regions may be exaggerated. Therefore, any implementation manner of this application is not necessarily limited to the dimensions shown in the figures, and the shape and size of the parts in the attached drawings do not reflect the actual proportion. In addition, the attached drawings schematically show ideal examples, and any implementation manner of this application is not limited to the shape or value shown in the attached drawings.

The above are only the specific implementation manners of this application, but the protection scope of this application is not limited thereto. Any person skilled in the technical field can easily think of changes or replacements within the technical scope disclosed by this application, and all of these should be covered within the protection scope of this application. Therefore, the protection scope of this application shall be subject to the protection scope of the claims.

1. A lens module, for a near-eye display device, comprising:
a first lens group, wherein the first lens group has a first surface facing eyes of a user and a first side surface connected to the first surface;
a second lens group, wherein the second lens group is connected to one end, away from the eyes of the user, of the first lens group; along a direction away from an optical axis of the lens module, the second lens group protrudes out of the first lens group to form a bearing platform; and the bearing platform is provided with first conductive pads; and
at least one eye tracking light source, wherein the at least one eye tracking light source is disposed on the first side surface, and is electrically connected with the first conductive pads through a conductive structure.

2. The lens module according to claim 1, wherein the at least one eye tracking light source comprises a plurality of eye tracking light sources, at least two of the plurality of eye tracking light sources are distributed at intervals along a circumferential direction of the lens module, and the plurality of eye tracking light sources are electrically connected with the first conductive pads through the conductive structure respectively.

3. The lens module according to claim 2, wherein the conductive structure comprises: a positive wire and a negative wire, wherein a positive electrode of each of the plurality of eye tracking light sources is connected with a first conductive pad, of the first conductive pads, corresponding to the positive electrode through the positive wire, and a negative electrode of each of the plurality of eye tracking light sources is connected with a first conductive pad, of the first conductive pads, corresponding to the negative electrode through the negative wire.

4. The lens module according to claim 2, further comprising second conductive pads, wherein the second conductive pads are located on the first side surface, and electrodes of the plurality of eye tracking light sources are connected with the conductive structure through the second conductive pads.

5. The lens module according to claim 4, wherein, along the circumferential direction of the lens module, a dimension of a second conductive pad of the second conductive pads ranges from 0.05 mm to 1 mm.

6. The lens module according to claim 4, wherein, along a direction of the optical axis of the lens module, a dimension of a second conductive pad of the second conductive pads ranges from 0.05 mm to 1 mm.

7. The lens module according to claim 4, wherein the plurality of eye tracking light sources and/or the electrodes of the plurality of eye tracking light sources are bonded to the first side surface.

8. The lens module according to claim 1, wherein, along a circumferential direction of the lens module, a width of the conductive structure ranges from 0.05 mm to 0.4 mm.

9. The lens module according to claim 1, wherein, along a direction towards the optical axis of the lens module, a thickness of the conductive structure ranges from 0.01 mm to 0.3 mm.

10. The lens module according to claim 1, wherein a resistance R of the conductive structure ranges from 10⁻⁵Ω to 10⁻³Ω.

11. The lens module according to claim 1, further comprising: a hardened protective layer covering at least the conductive structure and the first conductive pads.

12. The lens module according to claim 11, wherein a material of the hardened protective layer comprises a black material.

13. The lens module according to claim 11, wherein, along a direction towards the optical axis of the lens module, a thickness of the hardened protective layer ranges from 2 μm to 10 μm.

14. The lens module according to claim 11, further comprising: a base layer, wherein the base layer is located between the conductive structure and the first side surface, and is also located between the hardened protective layer and the first side surface.

15. The lens module according to claim 14, wherein a material of the base layer comprises a black material.

16. The lens module according to claim 14, wherein, along a direction towards the optical axis of the lens module, a thickness of the base layer ranges from 0.1 μm to 50 μm.

17. The lens module according to claim 1, wherein the first side surface comprises: an inclined section; along a direction towards the second lens group, a distance between the inclined section and the optical axis of the lens module gradually increases.

18. The lens module according to claim 17, wherein an angle θ between the inclined section and a preset direction satisfies: 40°≤θ<90°; wherein the preset direction is perpendicular to the optical axis of the lens module.

19. The lens module according to claim 17, wherein a minimum distance between an edge, away from the optical axis of the lens module, of the bearing platform and the first side surface ranges from 1 mm to 10 mm.

20. A near-eye display device, comprising: a lens cone and a lens module, wherein the lens module comprises:
a first lens group, wherein the first lens group has a first surface facing eyes of a user and a first side surface connected to the first surface;
a second lens group, wherein the second lens group is connected to one end, away from the eyes of the user, of the first lens group; along a direction away from an optical axis of the lens module, the second lens group protrudes out of the first lens group to form a bearing platform; and the bearing platform is provided with first conductive pads; and
at least one eye tracking light source, wherein the at least one eye tracking light source is disposed on the first side surface, and is electrically connected with the first conductive pads through a conductive structure,
wherein the lens module is connected with the lens cone.
